(19) United States
(12) Patent Application Publication
(10) Pub. No.: US 2009/0296398 A1
(43) Pub. Date: Dec. 3, 2009

(54) ELECTRONIC DEVICE

(75) Inventor: Tomofumi Miyamoto, Nishitama-gun (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/404,142

(22) Filed: Mar. 13, 2009

(30) Foreign Application Priority Data
May 30, 2008 (JP) 2008-143238

(51) Int. Cl. F21V 33/00; F21V 7/00

(52) U.S. Cl. 362/253; 362/310; 362/296.09

(57) ABSTRACT

According to one embodiment, an electronic device includes a housing including a recess portion and an ornamental lamp unit fit into the recess portion, wherein the ornamental lamp unit further includes a printed wiring board provided at a bottom of the recess portion, a light source mounted on the printed wiring board, and a first panel fixed to the housing such as to partition an outer environment and an inner side of the recess portion from each other and having translucency, and the first panel further includes a first surface set to face the light source and including a plurality of projection portions which diffuse light from the light source, and a second surface provided on an opposite side to the first surface, the second surface provided with a one-way mirror which transmits light from the light source and reflects light from the external environment.

### CROSS-REFERENCE TO RELATED APPLICATIONS

This application is based upon and claims the benefit of priority from Japanese Patent Application No. 2008-143238, filed May 30, 2008, the entire contents of which are incorporated herein by reference.

### BACKGROUND

1. Field

One embodiment of the present invention relates to an electronic device including an ornamental lamp unit in a part of its housing.

2. Description of the Related Art

Jpn. Pat. Appln. KOKAI Publication No. 2003-134210 discloses a mobile telephone device in which one light-emitting diode can illuminate a wide range area of its illuminated portion. This telephone device includes a rear case which forms a part of an enclosure, an illuminate portion made of a translucent white acryl resin and provided in a part of the rear case, a light-emitting diode which irradiates light onto the illuminated portion, a printed circuit board having an opening portion in which the light-emitting diode is housed, a diffusion sheet provided between the illuminated portion and the light-emitting diode, and a reflection sheet provided to face the opening portion of the printed circuit board.

The diffusion sheet is designed to diffusion light from the light-emitting diode so as to improve the light diffusion effect in the illuminated portion. The diffusion sheet is colored in pale gray so as to prevent a green portion of the printed circuit board being seen through the illuminated portion. The reflection sheet is provided at a position on an opposite side to the diffusion sheet with respect to the printed circuit board.

The mobile telephone device emits light from the light-emitting diode when a call or mail is received on the phone. A portion of the light is diffused by the diffusion sheet and irradiated onto the illuminated portion. Of the light emitted from the light-emitting diode, the portion irradiated in a direction along the printed circuit board reflects on the diffusion sheet and the reflection light is irradiated to an opposite side of the printed circuit board through the opening portion. This portion of light reflects on the reflection sheet and passes once again through the opening portion. Thus, the portion of light transmits through the diffusion sheet and then is irradiated onto the illuminated portion. In this manner, even the portion of light leaking in the direction along the printed circuit board can be reflected to the diffusion sheet by the reflection plate, and thus the light can be effectively used in full.

However, in the mobile telephone device, the reflection sheet must be prepared separately in addition to the diffusion sheet, thus increasing the number of parts. Further, the diffusion sheet is colored in light gray, but it has a translucency due to its characteristics. Therefore, the diffusion sheet does not fully serve the function of a blind, but there are possibilities that the color of the printed circuit board can be seen from outside while the light-emitting diode is turned off.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a portable computer, which is an example of the electronic device according to the first embodiment;

FIG. 2 is an exemplary cross sectional view of the portable computer shown in FIG. 1, taken along the line F2-F2;

FIG. 3 is an exemplary enlarged cross sectional view of the ornamental lamp unit of the portable computer shown in FIG. 2; and

FIG. 4 is an exemplary top view of the ornamental lamp unit of the portable computer shown in FIG. 1 shown from above.

### DETAILED DESCRIPTION

Various embodiments according to the invention will be described hereinafter with reference to the accompanying drawings. In general, according to one embodiment of the invention, an electronic device includes a housing including a recess portion and an ornamental lamp unit fit into the recess portion, wherein the ornamental lamp unit further includes a printed wiring board provided at a bottom of the recess portion, a light source mounted on the printed wiring board, and a first panel fixed to the housing such as to partition an outer environment and an inner side of the recess portion from each other and having translucency, and the first panel further includes a first surface set to face the light source and including a plurality of projection portions which diffuse light from the light source, and a second surface provided on an opposite side to the first surface, the second surface provided with a one-way mirror which transmits light from the light source and reflects light from the external environment.

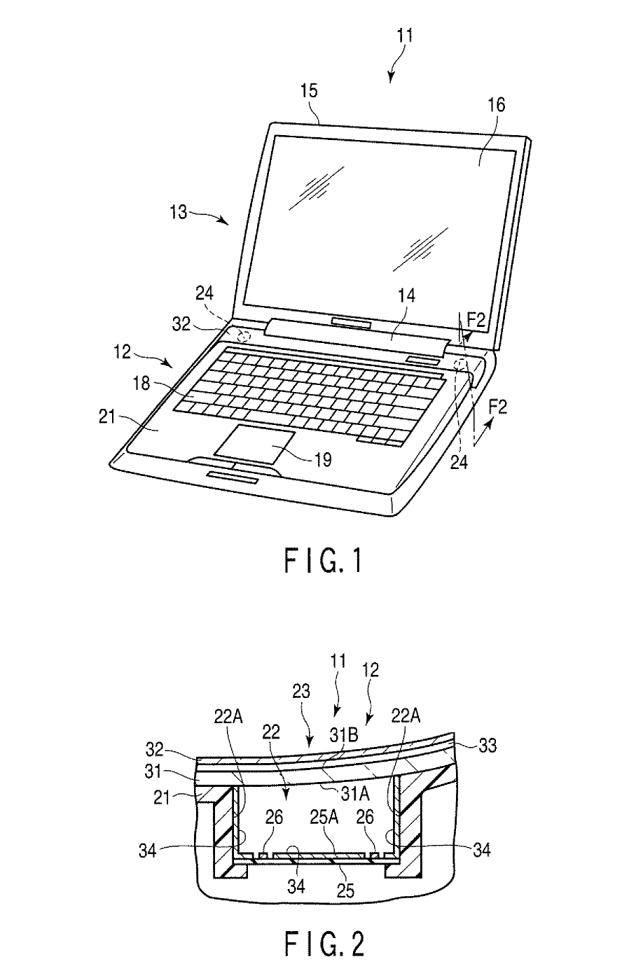

An embodiment of the electronic device will now be described with reference to FIGS. 1 to 4. This embodiment will be described in connection with a case where the present invention is applied to a portable computer, which is a so-called notebook-type personal computer as an example of the electronic device.

As shown in FIG. 1, a portable computer 11 includes a main body unit 12, a display unit 13 and a hinge portion 14 provided between the main body unit 12 and the display unit 13. The hinge portion 14 supports the display unit 13 so as to be pivotable. The hinge portion 14 supports the display unit 13 so as to be pivotable between a state where the display unit 13 is close to the main body unit 12 and a state where the display unit 13 is open to the main body unit 12.

As shown in FIG. 1, the display unit 13 includes a synthetic resin-made display cabinet 15 and a liquid crystal display 16, which is an example of the display housed inside the display cabinet 15.

As shown in FIGS. 1 and 2, the main body unit 12 includes a synthetic resin-made main body cabinet 21, a printed circuit board not shown in the figure but housed inside the main body cabinet 21, a keyboard 18 and a touch pad 19, which are mounted to the main body cabinet 21, a recess portion 22 made in the main body cabinet 21, an ornamental lamp unit 23 inserted to the recess portion 22, and loudspeaker devices 24 housed inside the main body cabinet 21. The printed circuit board is a main circuit board on which a plurality of circuit parts including CPU are mounted. The recess portion 22 is provided to be adjacent to the loudspeaker devices 24. It should be noted that the housing referred to in the present invention is of a concept which includes the display cabinet 15 and the main body cabinet 21.

As shown in FIGS. 1 and 4, the ornamental lamp unit 23 is provided in the vicinity of the loudspeaker devices 24. As shown in FIGS. 1, 2 and 4, the ornamental lamp unit 23 includes a printed wiring board 25 placed in the bottom of the recess portion 22, a light-emitting diode 26 which is a light source mounted on the printed wiring board 25, a first panel 31 fixed to the main body cabinet 21 such as to partition the outer field and the inner side of the recess portion 22, a second panel 32 provided at a position on an outer side to the first panel 31, a gap 33 provided between the first panel 31 and the second panel 32, a coating layer 34 provided on a surface 25A facing the first panel 31 of the printed wiring board 25 and an inner surface 22A of the recess portion 22. The light source used for the ornamental lamp unit 23 is not limited to the light-emitting diode 26, but it may be, for example, a light bulb.

The coating layer 34 is formed by applying a white paint. The coating layer 34 is formed on a top surface of the printed wiring board 25 and on the inner surface 22A of the recess portion 22. The coating layer 34 is formed by performing, for example, spray coating on the inner side of the recess portion 22 and the top surface of the printed wiring board 25 while the printed wiring board 25 is placed in the recess portion 22. For example, two of the light-emitting diodes 26 are mounted on the printed circuit board 25.

The second panel 32 is translucent. The second panel 32 is provided on an outer side to the first panel 31 mainly in order to protect a one-way mirror 42 of the first panel 31, which will be explained later. In this embodiment, the second panel 32 is formed to be transparent and colorless, for example, of an acryl resin. However, the present invention is not limited to this, but it may be colored in blue or yellow. When coloring is carried out on the second panel 32, the second panel 32 is made to have a function of a color filter. The second panel 32 has a through hole 35 at a position corresponding to each of the loudspeaker devices 24. The second panel 32 is fixed to the main body cabinet 21 such as to be flush with the surrounding main body cabinet 21.

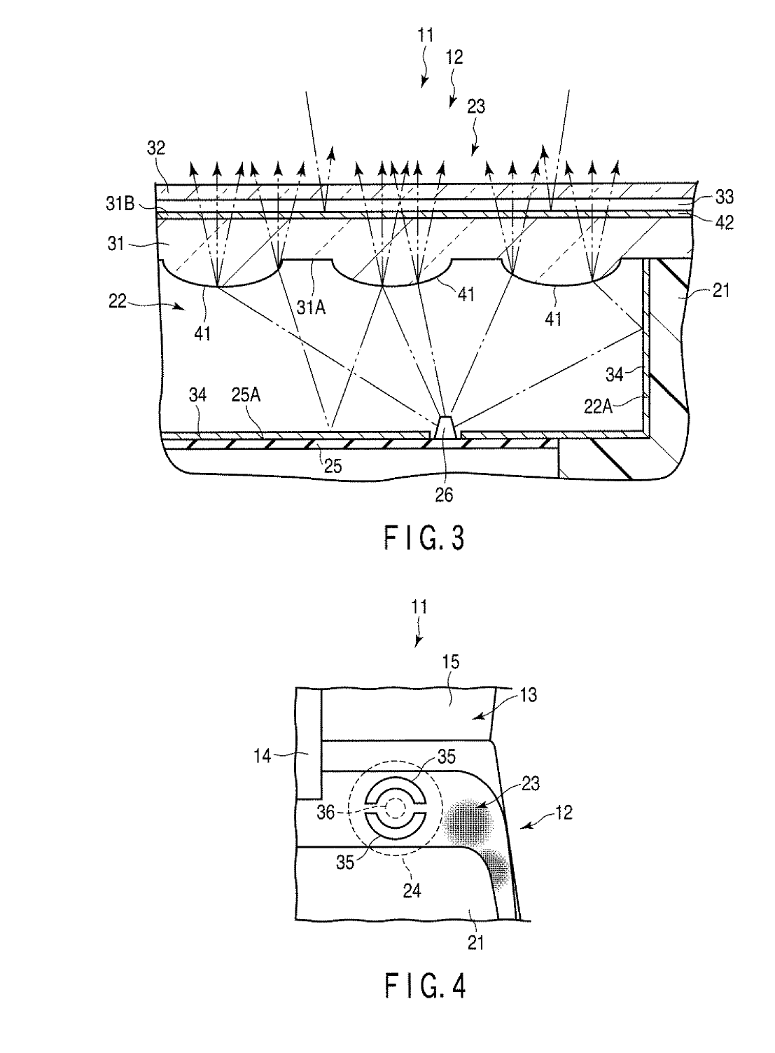

The first panel 31 is translucent. The first panel 31 is formed to be transparent and colorless, for example, of an acryl resin. The first panel 31 includes a first surface 31A facing the light-emitting diode 26, which is the light source, a second surface 31B located on an opposite side to the first surface 31A, and the through holes 36 respectively provided at the positions corresponding to the loudspeaker devices 24. As can be seen in FIG. 3, the first surface 31A includes a plurality of projection portions 41 which diffuse the light from the light-emitting diode 26. The projection portions 41 are each formed to have a shape of, for example, semi-sphere. In this embodiment, the semi-spherical projection portions 41 are formed on the first surface 31A as light diffusion means, so as to diffuse the light from the light-emitting diode 26. The light diffusion means provided on the first surface 31A are not limited to this type, but it is alternatively possible to provide a plurality of mountain-shaped projection portions 41 on the first surface 31A as other light diffusion means.

The one-way mirror 42 is provided on the second surface 31B of the first panel 31. The one-way mirror 42 is formed of a metal thin film deposited on the second surface 318. The one-way mirror 42 transmits the light from the light-emitting diode 26 serving as the light source towards the outside, and can reflect light from the outside towards the inner side of the recess portion 22.

Subsequently, the operation of the ornamental lamp unit 23 of this embodiment will now be described with reference to FIG. 3. Of the light emitted from the light-emitting diode 26, the portion directly irradiated onto the first panel 31 is diffused by the projection portions 41 of the first panel 31. The diffused light transmits the one-way mirror 42 of the first panel 31 and the second panel 32 to be irradiated to the external environment. In the meantime, of the light emitted from the light-emitting diode 26, the portion obliquely irradiated towards the inner side surface 22A of the recess portion 22 reflects on a coating layer 34 formed on the inner side surface 22A to be directed to the first panel 31. The reflection light is diffused by the projection portions 41 of the first panel 31 and irradiated to the outer environment. Further, the portion of the light reflecting on the first surface 31A of the first panel 31 to be irradiated towards the print wiring board 25 reflects on the coating layer 34 on the printed wiring board 25 to be directed towards the first panel 31. The reflection light is diffused by the projection portions 41 of the first panel 31 and irradiated to the outer environment. As described above, with the ornamental lamp unit 23 of the present embodiment, the portion of the light irradiated in the peripheral direction of the light-emitting diode 26 reflects on the coating layer 34 to be irradiated towards the first panel 31. The ornamental lamp unit 23 of this embodiment exhibits such a visual effect that as if there are a plurality of light sources when viewed from above as shown in FIG. 4. In FIG. 4, the light emitting portions of the first panel 31 and the second panel 32 are indicated by black dots.

It should be noted that although it is not shown in FIG. 3, light is refracted by a very small angle when it transmits the second panel 32, and therefore with the second panel 32, it is possible to create a depth at the position where the light source is provided. On the other hand, the light irradiated from the outer environment towards the inner side of the recess portion 22 reflects on the one-way mirror 42 to be irradiated towards the external environment once again.

According to this embodiment, the portable computer 11 comprises a cabinet including a recess portion 22 and an ornamental lamp unit 23 fit into the recess portion 22, wherein the ornamental lamp unit 23 further includes a printed wiring board 25 provided at the bottom of the recess portion 22, a light source mounted on the printed wiring board 25, and a first panel 31 fixed to the cabinet such as to partition the outer environment and the inner side of the recess portion 22 from each other and having translucency, and wherein the first panel further includes a first surface 31A set to face the light source and including a plurality of projection portions 41, and a second surface 31B provided on an opposite side to the first surface 31A, the second surface 31B provided with a one-way mirror 42 which transmits light from the light source and reflects light from the external environment.

With the above-described structure, the light irradiated from the light source is diffused by a plurality of projection portions 41 of the first panel 31 to be irradiated to the outside. As a result, such a visual effect similar to the case where the number of light sources is increased can be created for the user. Further, the one-way mirror 42 provided here can prevent light from the external environment from transmitting to the inner side of the deep section. In this manner, it is possible to prohibit the print wiring board 25 or light source, which is an internal structure of the ornamental lamp unit 23 from being seen from outside when the light source is turned off, which degrade the appearance of the device.

It is alternatively possible to further provide the second panel 32 having a translucency and provided at a position on an outer side to the first panel 31 with a gap between itself and the first panel 31.

With this structure, the second panel 32 serves to protect the one-way mirror 42. Further, the second panel 32 is provided with a gap 33 between the first panel 31 and itself, and therefore the light transmitting the second panel 32 is refracted. As a result, such a visual effect similar to that the light source is provided at a further deep section can be created for the user. Thus, the ornamental lamp unit 23 can exhibit a deep visual effect.

It is still alternatively possible to provide the coating layer 34 formed of a white paint on the surface 25A of the printed wiring board 25, which opposes the first panel 31 and on the inner side surface 22A of the recess portion 22. With this structure, the coating layer 34 serves to reflect the light from the light source towards the first panel 31. As a result, the illumination efficiency can be further improved with a less number of light sources.

It is still alternatively to provide the ornamental lamp unit 23 in the vicinity of the loudspeaker devices 24 housed inside the housing. With this structure, the area surrounding the loudspeaker devices 24 can be made even neater. In the vicinity of the loudspeaker devices 24 in particular, it is easy to reserve a space, and therefore by utilizing the space effectively, the appearance of the portable computer 11 can be improved.

The electronic device of the present invention is not limited to the above-described embodiment. For example, in the embodiment and its alternative versions discussed above, the ornamental lamp unit 23 is provided in the main body cabinet 21, but it is also possible to provide the ornamental lamp unit 23 in the display cabinet 15. Further, the electronic device of the present invention can be applied not only to the portable computer 11 but also a mobile telephone. Furthermore, it is only natural that the electronic device of the present invention can be remodeled into various different versions as long as the essence of the invention does not fall out of the scope thereof.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising a housing including a recess portion and an ornamental lamp unit fit into the recess portion, wherein:
the ornamental lamp unit further includes:
a printed wiring board provided at a bottom of the recess portion;
a light source mounted on the printed wiring board; and
a first panel fixed to the housing such as to partition an outer environment and an inner side of the recess portion from each other and having translucency;
and in that:
the first panel further includes:
a first surface set to face the light source and including a plurality of projection portions which diffuse light from the light source; and
a second surface provided on an opposite side to the first surface, the second surface provided with a one-way mirror which transmits light from the light source and reflects light from the external environment.

2. The electronic device of claim 1, further comprising a second panel having a translucency and provided at a position on an outer side to the first panel with a gap between itself and the first panel.

3. The electronic device of claim 2, further comprising a coating layer formed of a white paint on a surface of the printed wiring board, which opposes the first panel and on an inner side surface of the recess portion.

4. The electronic device of claim 3, wherein the ornamental lamp unit is provided in a vicinity of a loudspeaker device housed inside the housing.
